(19) United States
(12) Patent Application Publication
(10) Pub. No.: US 2023/0416561 A1
(43) Pub. Date: Dec. 28, 2023

(54) LIQUID APPLIED MEMBRANE WITH IMPROVED INTERCOAT ADHESION

(71) Applicant: SIKA TECHNOLOGY AG, Baar (CH)

(72) Inventors: John BARRATT, Manchester (GB); Mohammed Aadil PATEL, Preston (GB); Ian MARTIN, Clitheroe (GB); Alexander COWARD, Sale (GB); Alison MANNING, Preston (GB); Peter CORMACK, Glasgow (GB); Michael BYRNE, Lytham (GB)

(73) Assignee: SIKA TECHNOLOGY AG, Baar (CH)

(21) Appl. No.: 18/036,945

(22) PCT Filed: Dec. 8, 2021
(86) PCT No.: PCT/EP2021/084703

§ 371 Date: May 15, 2023

(30) Foreign Application Priority Data
Dec. 14, 2020 (EP) 20213873.1

(51) Int. Cl. C09D 175/08; C09D 5/00; C09D 7/63; C08G 18/75; C08G 18/48; C08G 18/38; C08G 18/66; E04D 7/00

(52) U.S. Cl. CPC C09D 175/08; C09D 5/002; C09D 7/63; C08G 18/755; C08G 18/4825; C08G 18/3893; C08G 18/6666; E04D 7/00

(57) ABSTRACT

A method for coating a surface, including the steps: a) applying a first layer of a moisture-curable composition onto a surface, b) optionally letting the applied moisture-curable composition cure into a dried first layer, c) applying a second layer of the moisture-curable composition onto the optionally dried first layer, wherein the moisture-curable composition includes: between 20 and 50 wt.-%, preferably between 25 and 45 wt.-%, based on the total weight of the composition, of at least one organic polymer which is liquid at room temperature and contains reactive silane groups, and between 10 and 30 wt.-%, preferably between 15 and 25 wt.-%, based on the total weight of the composition, of at least one polyether PE having between 2 and 6 ether oxygen atoms and is free of hydroxyl groups; and at least one curing catalyst for reactive silane groups. The method yields a multilayer coating with high intercoat adhesion.

### TECHNICAL FIELD

The invention relates to reactive polymer compositions which can be applied in liquid form and to application thereof as liquid applied membranes for sealing constructions against water penetration.

### PRIOR ART

Liquid-applicable reactive polymer compositions which are employed as crack-bridging coatings to seal constructions against water penetration have been known and used for some considerable time. They are also referred to as liquid applied membranes or “LAMs”. Relative to prefabricated sealing membranes, they afford greater ease of application, particularly on geometrically complex surfaces, improved protection from lateral migration, owing to the full-area adhesion to the substrate, and seamless laying. Relative to nonreactive liquid applied systems such as polymer solutions, aqueous polymer dispersions or products based on bitumen, they are distinguished by high strength and high elasticity, even under cold conditions, and do not readily attract dirt, and also provide long-term sealing even under standing water. To provide constructions with reliable protection from water penetration, the crack-bridging properties of a cured, liquid applied membrane over a wide temperature range is important. Accordingly, the cured material must possess high stretchability, high strength with not too high a modulus of elasticity, and good tear resistance. The known reactive liquid applied polymer membranes are typically isocyanate-containing polyurethanes, and are on the market as one-component, moisture-curing systems or as two-component systems. They do have good mechanical properties and resistance qualities, but they also have technical disadvantages. At the curing stage, for instance, they are sensitive to moisture and temperature. At high atmospheric humidity, especially in combination with high temperature, with a moist substrate or under direct water attack, there may be bubbles formed as a result of evolution of CO₂, causing the coating to foam up and impairing its sealing function and resistance qualities. Under warm conditions, they display a short pot-life or working life, and under cold conditions they cure very slowly or remain soft and tacky over the long term. Furthermore, they are under pressure from regulation, owing to the EHS-critical isocyanate monomers and the often high level of solvents, which cause unpleasant odors and VOC emissions, and for this reason there is an intensive search for alternatives.

As an isocyanate-free alternative to the liquid applied polyurethane membranes, those based on silane-functional polymers have been described, in EP 1 987 108, for example, or in US 2009/0226740. These products, however, have an undesirably high viscosity or contain a very high level of low molecular mass silanes in order to lower the viscosity, thereby causing severe emissions of low molecular mass alcohols and significant contraction on curing. Moreover, they cure slowly and develop strength only in a very limited way, meaning that they are not serviceable unless reinforced with a non-woven web, fabric or a glass-fibre scrim.

US 2020/0354584 and US 2017/0292050 both describe compositions based on silane-functional polymers that furthermore contain polyetherdiamines, which leads to compositions with relatively low viscosity and interesting mechanical and adhesive properties. However, in order to achieve sufficiently low viscosity for use as liquid applied membranes, addition of plasticizers or other diluents is required.

Also known are low viscosity polymer compositions based on a combination of silane-functional polymers with silane-functional, hydrophobic reactive diluents—from EP 2 561 024, for example. Such systems provide the necessary low viscosity, together with an excellent water-repellent effect by incorporating hydrophobic organosilanes as reactive diluents, but they suffer, from poor intercoat adhesion when layers of liquid-applied membranes are applied. This is often encountered in liquid applied membranes based on silane-functional polymers. In many applications, layers of the composition need to be applied on top of each other, in order to obtain a water-repellent coating, especially when applying over large areas, or when applications cannot be completed on the same day. However, these liquid applied membranes, especially once dried completely, often fail to generate a proper adhesion with the subsequently applied, fresh composition on top as second layer. The result is poor intercoat adhesion between the different layers applied in individual process steps, which then leads to poor performance of the multilayer coating under mechanical or ambient influences. This poor intercoat adhesion can result in a seal that is not watertight.

### SUMMARY OF THE INVENTION

It is an object of the present invention to provide a method for coating or sealing a surface in construction by using a liquid-applicable, reactive polymer composition, free of isocyanate groups, which is low in odor, low in toxicity, low in methanol emissions, long in shelf-life, and easy to work by means of manual application by exhibiting a low viscosity. This cures rapidly and without destruction at ambient temperature, and shows excellent intercoat adhesion when applied in layers, even when the base layer has been dried for several days or longer.

It has been found that, surprisingly, this object is achieved by a method using a composition as claimed in claim 1. The composition possesses a low odor and a low toxicity and is of low viscosity. At room temperature it cures rapidly, and forms a high-grade, macroscopically homogeneous, non-tacky material having good mechanical properties and with high resistance to water, heat, and UV radiation. On account of these properties, the liquid composition can be easily applied and worked as a multi-layer sealing membrane, cures rapidly even in a moist or cool environment, and forms a high-quality polymeric membrane with an attractive surface and long weathering stability qualities.

A particular surprise here is that the liquid applied membrane can be applied in layers and exhibits an unprecedented intercoat adhesion between these layers, even if the base layer has been dried for several days or longer before the upper layer is applied thereon.

Further aspects of the invention are the subject of further independent claims. Particularly preferred embodiments of the invention are the subject of the dependent claims.

Ways of Executing the Invention

The invention provides for the method for coating a surface, comprising the steps:
a) applying a first layer of a moisture-curable composition onto a surface, b) optionally letting the applied moisture-curable composition cure into a dried first layer,
c) applying a second layer of said moisture-curable composition onto the optionally dried first layer,
wherein said moisture-curable composition comprises
   between 20 and 50 wt.-%, preferably between 25 and 45 wt.-%, based on the total weight of the composition, of at least one organic polymer which is liquid at room temperature and contains reactive silane groups, and
   between 10 and 30 wt.-%, preferably between 15 and 25 wt.-%, based on the total weight of the composition, of at least one polyether PE having between 2 and 6 ether oxygen atoms and is free of hydroxyl groups; and
   at least one curing catalyst for reactive silane groups.

In the present document, the term “alkoxysilane group” or “silane group” for short, refers to a silyl group which is bonded to an organic radical and has one to three, especially two or three, hydrolyzable alkoxy radicals on the silicon atom.

Correspondingly, the term “organosilane” or “silane” for short, refers to an organic compound which contains at least one silane group. “Aminosilane”, “mercaptosilane”, “hydroxysilane” and “isocyanatosilane” refer respectively to organosilanes having one or more amino, mercapto, hydroxyl or isocyanate groups on the organic radical in addition to the silane group.

The term “polyether containing silane groups” also encompasses polymers which contain silane groups and which, in addition to polyether units, may also contain urethane groups, urea groups or thiourethane groups. Such polyethers containing silane groups may also be referred to as “polyurethanes containing silane groups”.

Substance names beginning with “poly”, such as polyamine or polyisocyanate, refer to substances containing, in a formal sense, two or more of the functional groups that occur in their name per molecule.

An “aliphatic polyamine” is a polyamine whose amino groups are bonded to an aliphatic or cycloaliphatic or arylaliphatic radical.

A “primary amino group” refers to an amino group which is bonded to a single organic radical and bears two hydrogen atoms; a “primary aminosilane” thus refers to an organosilane having a primary amino group in the non-hydrolyzable organic rest bound to the silicon atom.

“Molecular weight” refers to the molar mass (in g/mol) of a molecule. “Average molecular weight” is the number average Mₙ of a polydisperse mixture of oligomeric or polymeric molecules, which is typically determined by means of gel permeation chromatography (GPC) against polystyrene as standard.

“Viscosity” refers to the dynamic viscosity or shear viscosity which is defined by the ratio between the shear stress and the shear rate (speed gradient) and is determined as described in the working examples.

A substance or composition is referred to as “storage-stable” or “storable” when it can be stored at room temperature in a suitable container over a prolonged period, typically over at least 3 months up to 6 months or more, without any change in its application or use properties to a degree of relevance for the use thereof as a result of the storage.

The abbreviation “VOC” stands for “volatile organic compounds”, i.e. volatile organic substances having a vapor pressure of at least 0.01 kPa at 293.14 K. “Solvent” is a liquid which dissolves the polymer containing silane groups and/or the liquid epoxy resin and which is a VOC and contains no groups that are reactive toward silane or epoxide groups.

A dotted line in the formulae in this document in each case represents the bond between a substituent and the corresponding molecular radical.

“Room temperature” refers to a temperature of 23° C.

The composition comprises at least one polymer which is liquid at room temperature and contains silane groups.

This is preferably an organic polymer containing silane groups, more particularly a polyolefin, poly(meth)acrylate or polyether or a mixed form of these polymers, each of which bears one or preferably more than one silane group. The silane groups may be pendant from the chain or terminal.

In particular, the polymer containing silane groups is a polyether containing silane groups. This polyether preferably has a majority of oxyalkylene units, more particularly 1,2-oxypropylene units.

The polymer containing silane groups and liquid at room temperature has an average of preferably 1.3 to 4, especially 1.5 to 3, more preferably 1.7 to 2.8, silane groups per molecule. The silane groups are preferably terminal.

Preferred silane groups are trimethoxysilane groups, dimethoxymethylsilane groups or triethoxysilane groups.

The polymer containing silane groups and liquid at room temperature preferably has an average molecular weight, determined by means of GPC relative to a polystyrene standard, in the range from 1000 to 20 000 g/mol, in particular from 2000 to 15 000 g/mol.

The polymer containing silane groups preferably comprises end groups of the formula (II),

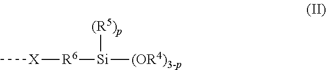

where
p stands for a value of 0 or 1 or 2, preferably 0 or 1, more particularly 0,
R⁴ is a linear or branched, monovalent hydrocarbyl radical having 1 to 5 carbon atoms,
R⁵ is a linear or branched, monovalent hydrocarbyl radical having 1 to 8 carbon atoms, especially methyl or ethyl,
R⁶ is a linear or branched, divalent hydrocarbyl radical which has 1 to 12 carbon atoms and which optionally contains cyclic and/or aromatic moieties and optionally one or more heteroatoms, especially one or more nitrogen atoms,
X is a divalent radical selected from —O—, —S—, —N(R⁷)—,
N(R⁷)—OO—, —O—CO—N(R⁷)—, —N(R⁷)—OO—O—, —N(R⁷)—CO—N(R⁷)—,
—N(R⁷)—CO—O—CH(CH₃)—CO—N(R⁷)—,
—N(R⁷)—CO—O—CH(R⁸)—CH₂—CH₂—CO—N(R⁷)— and
—N(R⁷)—OO—O—CH(CH₃)—CH₂—O—CO—N(R⁷)—,
   where
   R⁷ is a hydrogen atom or is a linear or branched hydrocarbyl radical
   which has 1 to 20 carbon atoms and which optionally contains cyclic moieties, and which optionally contains an alkoxysilyl group or ether or carboxylic ester groups,
   and R⁸ is an unbranched alkyl radical having 1 to 6 carbon atoms, more particularly methyl.

Preferably R⁴ is methyl or is ethyl or is isopropyl.

More preferably, R⁴ is methyl. Polymers of this kind containing silane groups are particularly reactive.

More preferably, moreover, R⁴ is ethyl. Polymers of this kind containing silane groups are particularly stable on storage and toxicologically advantageous.

Preferably, R⁵ is methyl.

Preferably, R⁶ is 1,3-propylene or 1,4-butylene, where butylene may be substituted by one or two methyl groups.

More preferably, R⁶ is 1,3-propylene.

Processes for preparing polyethers containing silane groups are known to the person skilled in the art.

In one process, polyethers containing silane groups are obtainable from the reaction of polyethers containing allyl groups with hydrosilanes (hydrosilylation), optionally with chain extension using, for example, diisocyanates.

In another process, polyethers containing silane groups are obtainable from the copolymerization of alkylene oxides and epoxysilanes, optionally with chain extension using, for example, diisocyanates.

In a further process, polyethers containing silane groups are obtainable from the reaction of polyether polyols with isocyanatosilanes, optionally with chain extension using diisocyanates.

In a further process, polyethers containing silane groups are obtainable from the reaction of polyethers containing isocyanate groups, especially NCO-terminated urethane polyethers from the reaction of polyether polyols with a superstoichiometric amount of polyisocyanates, with aminosilanes, hydroxysilanes or mercaptosilanes. Polyethers containing silane groups from this process are particularly preferred. This process enables the use of a multitude of inexpensive starting materials of good commercial availability, by means of which it is possible to obtain different polymer properties, for example high stretchability, high strength, low glass transition temperature, or high resistance to hydrolysis.

Preferred polyethers containing silane groups are obtainable from the reaction of NCO-terminated urethane polyethers with aminosilanes or hydroxysilanes. NCO-terminated urethane polyethers suitable for this purpose are obtainable from the reaction of polyether polyols, especially polyoxyalkylenediols or polyoxyalkylenetriols, preferably polyoxypropylenediols or polyoxypropylenetriols, with a superstoichiometric amount of polyisocyanates, especially diisocyanates.

Preferably, the reaction between the polyisocyanate and the polyether polyol is conducted with exclusion of moisture at a temperature of 50° C. to 160° C., optionally in the presence of suitable catalysts, with metered addition of the polyisocyanate in such a way that the isocyanate groups thereof are present in a stoichiometric excess in relation to the hydroxyl groups of the polyol. More particularly, the excess of polyisocyanate is chosen such that a content of free isocyanate groups in the range from 0.1° A to 10% by weight, preferably 0.2% to 5% by weight, more preferably 0.3% to 3% by weight, based on the overall polymer, remains in the resulting urethane polyether after the reaction of all hydroxyl groups.

Preferred diisocyanates are selected from the group consisting of hexamethylene 1,6-diisocyanate (HDI), 1-isocyanato-3,3,5-trimethyl-5-isocyanatomethylcyclohexane (=isophorone diisocyanate or IPDI), tolylene 2,4- and 2,6-diisocyanate and any desired mixtures of these isomers (TDI) and diphenylmethane 4,4′-, 2,4′- and 2,2′-diisocyanate and any desired mixtures of these isomers (MDI). Particular preference is given to IPDI or TDI. Most preferred is IPDI. In this way, polyethers containing silane groups with particularly good weatherability are obtained.

Especially suitable as polyether polyols are polyoxyalkylenediols or polyoxyalkylenetriols having a degree of unsaturation lower than 0.02 meq/g, especially lower than 0.01 meq/g, and an average molecular weight in the range from 400 to 20 000 g/mol, especially 1000 to 15 000 g/mol.

As well as polyether polyols, it is also possible to use proportions of other polyols, especially polyacrylate polyols or polyester polyols, and also low molecular weight diols or triols.

Suitable aminosilanes for the reaction with an NCO-terminated urethane polyether are primary or secondary aminosilanes. Preference is given to 3-aminopropyltrimethoxysilane, 3-am inopropyldimethoxymethylsilane, 4-aminobutyltrimethoxysilane, 4-amino-3-methylbutyltrimethoxysilane, 4-amino-3,3-dimethylbutyltrimethoxysilane, N-butyl-3-am inopropyltrimethoxysilane, N-phenyl-3-aminopropyltrimethoxysilane, adducts formed from primary amino-silanes such as 3-am inopropyltrimethoxysilane, 3-aminopropyldimethoxy-methylsilane or N-(2-aminoethyl)-3-am inopropyltrimethoxysilane and Michael acceptors such as acrylonitrile, (meth)acrylic esters, (meth)acrylam ides, maleic or fumaric diesters, citraconic diesters or itaconic diesters, especially dimethyl or diethyl N-(3-trimethoxysilylpropyl)aminosuccinate. Likewise suitable are analogues of the aminosilanes mentioned with ethoxy or isopropoxy groups in place of the methoxy groups on the silicon.

Suitable hydroxysilanes for the reaction with an NCO-terminated urethane polyether are especially obtainable from the addition of aminosilanes onto lactones or onto cyclic carbonates or onto lactides.

Preferred hydroxysilanes of this kind are N-(3-triethoxysilylpropyl)-2-hydroxypropanamide, N-(3-trimethoxysilylpropyl)-2-hydroxypropanamide, N-(3-triethoxysi lylpropyl)-4-hydroxypentanam ide, N-(3-triethoxysilylpropyI)-4-hydroxyoctanamide, N-(3-triethoxysilylpropyI)-5-hydroxydecanamide or N-(3-triethoxysilylpropyl)-2-hydroxypropyl carbamate.

Further suitable hydroxysilanes are obtainable from the addition of aminosilanes onto epoxides or from the addition of amines onto epoxysilanes. Preferred hydroxysilanes of this kind are 2-morpholino-4(5)-(2-trimethoxysilylethyl)cyclohexan-1-ol, 2-morpholino-4(5)-(2-triethoxysilyl-ethyl)cyclohexan-1-ol or 1-morpholino-3-(3-(triethoxysilyl)propoxy)propan-2-ol.

Further suitable polyethers containing silane groups are commercially available products, especially the following: MS Polymer™ (from Kaneka Corp.; especially the 5203H, 5303H, S227, S810, MA903 and S943 products); MS Polymer™ or Silyl™ (from Kaneka Corp.; especially the SAT010, SAT030, SAT200, SAX350, SAX400, SAX725, MAX450, MAX951 products); Excestar® (from Asahi Glass Co. Ltd.; especially the S2410, S2420, S3430, S3630 products); SPUR+* (from Momentive Performance Materials; especially the 1010LM, 1015LM, 1050MM products); Vorasil™ (from Dow Chemical Co.; especially the 602 and 604 products); Desmoseal® (from Covestro; especially the S XP 2458, S XP 2636, S XP 2749, S XP 2774 and S XP 2821 products), TEGOPAC® (from Evonik Industries AG; especially the Seal 100, Bond 150, Bond 250 products), Polyvest® (from Evonik; especially the EP ST-M and EP ST-E products), Polymer ST (from Hanse Chemie AG/Evonik Industries AG, especially the 47, 48, 61, 61LV, 77, 80, 81 products); Geniosil® STP (from Wacker Chemie AG; especially the E10, E15, E30, E35 products) or Arufon (from Toagosei, especially the US-6100 or US-6170 products).

Particularly preferred as polymer containing silane groups is a polyether containing silane groups which in addition to silane groups also contains urethane groups and/or urea groups. These result typically from the reaction of isocyanate groups with hydroxyl groups or with primary or secondary amino groups. A polymer of this kind containing silane groups enables particularly rapid curing and particularly good mechanical properties.

The amount of polymer containing silane groups in the composition is preferably in the range from 10 to 80% by weight, more preferably in the range from 15 to 70% by weight, more particularly in the range from 15 to 60% by weight.

The composition preferably further comprises at least one aminosilane or epoxysilane or mercaptosilane.

A suitable epoxysilane is especially 3-glycidoxypropyltrimethoxysilane or 3-glycidoxypropyldimethoxymethylsilane or 3-glycidoxypropyltriethoxysilane.

A suitable mercaptosilane is especially 3-mercaptopropyltrimethoxysilane or 3-mercaptopropyldimethoxymethylsilane or 3-mercaptopropyltriethoxysilane.

With particular preference the composition comprises at least one aminosilane. An aminosilane not only acts as a silane-functional crosslinker for the efficient curing of silane-functional polymers, but also as an adhesion promoter via its amino function and, more importantly, as a curing catalyst for the cross-linking reaction due to its alkaline amino group.

A suitable aminosilane is especially selected from the group consisting of 3-aminopropyltrimethoxysilane, N-(2-aminoethyl)-3-am inopropyltrimethoxysilane, 3-amino-2-methylpropyltrimethoxysilane, 4-am inobutyltrimethoxysilane, 4-amino-3,3-dimethylbutyltrimethoxysilane, 3-aminopropyldimethoxymethylsilane, N-(2-am inoethyl)-3-aminopropyldimethoxymethylsilane and N-(2-aminoethyl)-N′-[3-(trimethoxysilyl)propyl]ethylenediamine, and also analogs thereof with ethoxy groups instead of the methoxy groups on the silicon.

Particularly preferred among these is 3-aminopropyltrimethoxysilane, 3-aminopropyltriethoxysilane, N-(2-aminoethyl)-3-am inopropyltrimethoxysilane or N-(2-am inoethyl)-3-am i nopropyltriethoxysi lane.

The composition preferably contains at least one am inosilane in an amount in the range from 0.1° A to 1° A by weight, especially in the range from 0.2% to by weight.

With preference the composition additionally comprises at least one further drier, also called moisture-scavenger. Driers improve the storage stability by capturing free or adsorbed water in the container, for example stemming from fillers.

Particularly suitable driers are tetraethoxysilane, vinyltrimethoxysilane, vinyltriethoxysilane, organosilanes having a functional group in α-position to the silane group, especially N-(methyldimethoxysilylmethyl)-O-methylcarbamate or (methacryloyloxymethyl)silanes, methoxymethylsilanes, orthoformic esters, and also calcium oxide or molecular sieves.

With particular preference the composition comprises vinyltrimethoxysilane or vinyltriethoxysilane. Here, vinyltrimethoxysilane is preferred when the polymer containing silane groups has methoxysilane groups, while vinyltriethoxysilane is preferred when the polymer containing silane groups has ethoxysilane groups.

In the case of a two-component composition, the drier, more particularly the vinyltrimethoxy- or -triethoxysilane, is preferably in the same component as the polymer containing silane groups.

Suitable catalysts for the curing of silane-functional polymers are substances which accelerate the crosslinking of polymers containing silane groups. Particularly suitable for this purpose are metal catalysts and/or nitrogen-containing compounds.

Suitable metal catalysts are compounds of titanium, zirconium, aluminum, or tin, especially organotin compounds, organotitanates, organozirconates or organoaluminates, these metal catalysts having, in particular, alkoxy groups, aminoalkoxy groups, sulfonate groups, carboxyl groups, 1,3-diketonate groups, 1,3-ketoesterate groups, dialkyl phosphate groups or dialkyl pyrophosphate groups.

Particularly suitable organotin compounds are dialkyltin oxides, dialkyltin dichlorides, dialkyltin dicarboxylates or dialkyltin diketonates, especially dibutyltin oxide, dibutyltin dichloride, dibutyltin diacetate, dibutyltin dilaurate, dibutyltin diacetylacetonate, dioctylyin oxide, dioctylyin dichloride, dioctyltin diacetate, dioctyltin dilaurate or dioctyltin diacetylacetonate, and also alkyltin thioesters.

Particularly suitable organotitanates are bis(ethylaceto-acetato)diisobutoxytitanium(IV), bis(ethylacetoacetato)diisopropoxytitanium(IV), bis(acetylacetonato)diisopropoxytitanium(IV), bis(acetylacetonato)diisobutoxy-titanium(IV), tris(oxyethyl)amine-isopropoxy-titanium(IV), bis[tris(oxyethyl)-amine]diisopropoxytitanium(IV), bis(2-ethylhexane-1,3-dioxy)titanium(IV), tris[2-((2-aminoethyl)amino)ethoxy]ethoxytitanium(IV), bis(neopentyl(diallyl)oxy)-diethoxytitanium(IV), titanium(IV) tetrabutoxide, tetra(2-ethylhexyloxy) titanate, tetra(isopropoxy) titanate or polybutyl titanate. Especially suitable are the commercially available products Tyzor® AA, GBA, GBO, AA-75, AA-65, AA-105, DC, BEAT, BTP, TE, TnBT, KTM, TOT, TPT or IBAY (all from Dorf Ketal); Tytan PBT, TET, X85, TAA, ET, S2, S4 or S6 (all from Borica Company Ltd.) and Ken-React® KR® TTS, 7, 9QS, 12, 26S, 33DS, 38S, 39DS, 44, 134S, 138S, 133DS, 158FS or LICA® 44 (all from Kenrich Petrochemicals). Particularly suitable organozirconates are the commercially available products Ken-React® NZ® 38J, KZ® TPPJ, KZ® TPP, NZ® 01, 09, 12 38, 44 or 97 (all from Kenrich Petrochemicals) or Snapcure® 3020, 3030, 1020 (all from Johnson Matthey & Brandenberger).

A particularly suitable organoaluminate is the commercially available product K-Kat 5218 (from King Industries).

Nitrogen-containing compounds with particular suitability as catalysts are amines such as, in particular, N-ethyldiisopropylamine, N,N,N′,N′-tetramethylalkylenediamines, polyoxyalkyleneamines, 1,4-diazabicyclo[2.2.2]octane; amidines such as, in particular, 1,8-diazabicyclo[5.4.0]undec-7-ene (DBU), 1,5-diazabicyclo[4.3.0]non-5-ene (DBN), 6-dibutylamino-1,8-diazabicyclo[5.4.0]undec-7-ene; guanidines such as, in particular, tetramethylguanidine, 2-guanidinobenzim idazole, acetylacetoneguanidine, 1,3-di-o-tolylguanidine, 2-tert-butyl-1,1,3,3-tetramethylguanidine, or reaction products of carbodiimidenes and amines such as, in particular, polyetheramines or aminosilanes as described above; or imidazoles such as, in particular, N-(3-trimethoxysilylpropyl)-4,5-dihydroimidazole or N-(3-triethoxysilylpropyI)-4,5-dihydroimidazole.

Also especially suitable are combinations of different catalysts for the crosslinking of polymers containing silane groups, more particularly combinations of at least one metal catalyst and at least one nitrogen-containing compound.

Preferred are organotin compounds, organotitanates, amines, amidines, guanidines or imidazoles.

In especially preferred embodiments, said curing catalyst is a combination of a primary aminosilane and a metal complex, said metal complex in particular 20 being a tin complex. Preferably, the composition comprises between 0.5 and 1.0 wt.-% of said primary aminosilane and between 0.01 and 0.1 wt.-% of said metal complex. These respective amounts allow for an efficient curing but still a beneficially low toxicity rating of the composition.

The composition to be used in the method according to the present invention furthermore comprises between 10 and 30 wt.-%, preferably between 15 and 25 wt.-%, most preferably between 17 and 23 wt.-%, based on the total weight of the composition, of at least one polyether PE having between 2 and 6 ether oxygen atoms and is free of hydroxyl groups. Instead of hydroxyl groups, the polyethers PE contain alkoxy end groups, preferably methoxy, ethoxy, butoxy or propoxy end groups, most preferably methoxy end groups. Polyether PE does not contain silane groups, amino groups, or other functional groups with heteroatoms except for ether oxygens.

In preferred embodiments, said polyether PE contains between 4 and 12 carbon atoms, preferably between 6 and 12 carbon atoms, and said ether oxygen atoms are bridged by 1 or 2 carbon atoms. The bridging units may be branched. However, the branching carbon atoms do not count as bridging, but only the carbon atoms directly linking the ether oxygen atoms.

Preferably, said polyether PE is an aliphatic polyether.

Suitable as polyether PE are in particular glycol ethers with no remaining free hydroxyl groups, in particular ethylene glycol ethers, propylene glycol ethers, and acetals. This means all previously present hydroxyl groups were converted to ether groups.

Glycol ethers suitable as polyether PE include, for example, ethylene glycol dimethyl ether, ethylene glycol diethyl ether, ethylene glycol dibutyl ether, ethylene glycol diphenyl ether, diethylene glycol dimethyl ether, diethylene glycol diethyl ether, diethylene glycol di-n-butyl ether, diethylene glycol propyl ether, dipropylene glycol dimethyl ether, dipropylene glycol diethyl ether, dipropylene glycol di-n-butyl ether, dipropylene glycol dipropyl ether, and 2,5,7,10-tetraoxaundecane.

Most preferably, said polyether PE is selected from dipropylene glycol dimethyl ether, dipropylene glycol diethyl ether, dipropylene glycol dibutyl ether, dipropylene glycol dipropyl ether, and 2,5,7,10-tetraoxaundecane.

The composition according to the present invention may contain plasticizers, however it is preferred that the amount of plasticizers included is 30 wt.-% or less, based on the total composition. Polyethers PE are not considered to fall under the definition of such plasticizers. Preferably, the composition to be used in the method according to the invention contains less than 20 wt.-% of plasticizers, in particular less than 10 wt.-%, based on the total composition.

Suitable plasticizers are especially carboxylic esters such as phthalates, especially diisononyl phthalate (DINP), diisodecyl phthalate (DIDP) or di(2-propylheptyl) phthalate (DPHP), hydrogenated phthalates, especially hydrogenated diisononyl phthalate (DINCH), terephthalates, especially dioctyl terephthalate, trimellitates, adipates, especially dioctyl adipate (DOA), azelates, sebacates, polyols, especially polyoxyalkene polyols or polyester polyols, benzoates, glycol ethers, glycol esters, organic phosphoric, phosphonic or sulfonic esters, polybutenes, polyisobutenes, or plasticizers derived from natural fats or oils, especially epoxidized soybean oil or linseed oil. Preferred is DINP, DIDP or DOA.

Most preferred plasticizers, if used at all, are flame-retardant plasticizers, especially organic phosphoric esters such as, in particular, triethyl phosphate, tricresyl phosphate, triphenyl phosphate, diphenyl cresyl phosphate, isodecyl diphenyl phosphate, tris(1,3-dichloro-2-propyl) phosphate, tris(2-chloroethyl) phosphate, tris(2-ethylhexyl) phosphate, tris(chloroisopropyl) phosphate, tris(chloropropyl) phosphate, isopropylated triphenyl phosphate, mono-, bis- or tris(isopropylphenyl) phosphates of different degrees of isopropylation, resorcinol bis(diphenyl phosphate) or bisphenol A bis(diphenyl phosphate). Diphenyl cresyl phosphate is preferred.

Further suitable constituents of the composition are in particular the following auxiliaries and adjuvants:
adhesion promoters and/or crosslinkers, especially (meth) acrylosilanes, anhydridosilanes, carbamatosilanes, alkylsilanes or iminosilanes, or oligomeric forms of these silanes, or adducts of primary am inosilanes with epoxysilanes or (meth)acrylosilanes or anhydridosilanes;
solvents, diluents or extenders, such as especially xylene, 2-methoxyethanol, dimethoxyethanol, 2-ethoxyethanol, 2-propoxyethanol, 2-isopropoxyethanol, 2-butoxyethanol, 2-phenoxyethanol, 2-benzyloxyethanol, benzyl alcohol, ethylene glycol, diethylene glycol, diethylene glycol monomethyl ether, diethylene glycol monoethyl ether, diethylene glycol mono-n-butyl ether, propylene glycol butyl ether, propylene glycol phenyl ether, dipropylene glycol, dipropylene glycol monomethyl ether, N-methylpyrrolidone, diphenylmethane, diisopropylnaphthalene, mineral oil fractions, for example Solvesso® products (from Exxon), alkylphenols such as tert-butylphenol, nonylphenol, dodecylphenol or cardanol (from cashewnut-shell oil, containing as main constituent, 3-(8,11,14-pentadeca-trienyl)phenol), styrenized phenol, bisphenols, aromatic hydrocarbon resins, especially types containing phenol groups, alkoxylated phenol, especially ethoxylated or propoxylated phenol, especially 2-phenoxyethanol, adipates, sebacates, phthalates, benzoates, organic phosphoric or sulfonic esters or sulfonamides;
inorganic or organic fillers, especially ground or precipitated calcium carbonates, optionally coated with fatty acids, especially stearates; baryte (heavy spar), talc, quartz flour, quartz sand, iron mica, dolomite, wollastonite, kaolin, mica (potassium aluminum silicate), molecular sieve, aluminum oxide, aluminum hydroxide, magnesium hydroxide, silica, cement, gypsum, fly ash, carbon black, graphite, metal powders such as aluminum, copper, iron, zinc, silver or steel, PVC powders or hollow spheres;
fibers, especially glass fibers, carbon fibers, metal fibers, ceramic fibers, polymer fibers such as polyamide fibers or polyethylene fibers, or natural fibers such as wool, cellulose, hemp or sisal;
inorganic or organic pigments, especially titanium dioxide, chromium oxide or iron oxide;
dyes;
rheology modifiers, especially thickeners, especially sheet silicates such as bentonites, derivatives of castor oil such as hydrogenated castor oil, polyamides, polyurethanes, urea compounds, polyvinyl chlorides, fumed silicas;
natural resins, fats or oils such as rosin, shellac, linseed oil, castor oil or soya oil;
nonreactive polymers, especially homo- or copolymers of unsaturated monomers, especially from the group comprising ethylene, propylene, butylene, isobutylene, isoprene, vinyl acetate or alkyl (meth)acrylates, especially polyethylenes (PE), polypropylenes (PP), polyisobutylenes, ethylene-vinyl acetate copolymers (EVA) or atactic poly-α-olefins (APAO);
flame retardants, especially the aforementioned fillers aluminum hydroxide or magnesium hydroxide, boron compounds, antimony trioxide, phosphorous, or the flame-retardant plasticizers already stated; or
additives, especially wetting agents, flow control agents, defoamers, deaerators, stabilizers against oxidation, heat, light or UV radiation, or biocides.

It may be useful to dry certain constituents chemically or physically before mixing them into the composition, particularly if they are to be stored together with the polymer containing silane groups.

Preferably, the moisture-curable composition according to the invention contains less than 5 wt.-%, based on the total composition, of aliphatic or aromatic alkylalkoxysilanes, in particular alkyltrialkoxysilanes and/or alkyldialkoxysilanes. In particular alkyltrialkoxysilanes such as octyltrialkoxysilane and phenyltrialkoxysilane should be used in amounts less than 5 wt.-%, preferably less than 2 wt.-%, if used at all. Such compounds do lead to low viscosity and fast curing but are detrimental to a good intercoat adhesion in cases where the top layer is applied onto a base layer that has been dried for more than 2 days. Furthermore, excessive amounts of organosilanes with two or three methoxy groups lead to increased levels of methanol side products that are released into the environment during curing of the composition.

Preferably, the moisture-curable composition additionally comprises between 10 wt.-% and 50 wt.-%, in particular between 20 wt.-% and 40 wt.-%, of at least one filler, preferably selected from chalk, aluminium hydroxide, and titanium dioxide, or mixtures thereof.

In particular a mixture of chalk, aluminium hydroxide and titanium dioxide offers a beneficial range of additional properties without making the composition too expensive, including increased flame-retardant properties and lightfastness, as well as mechanical improvements.

The composition preferably additionally comprises at least one further constituent selected from moisture scavengers, UV absorbers and stabilizers, pigments, and rheology modifiers. In preferred embodiments, all of these additives are comprised in the composition. Such a composition is especially stable against outdoor UV influences and especially storage stable and especially convenient to apply as a liquid-applied membrane.

For use as a sealing membrane, the composition is produced and used preferably in the form of a one component composition. The composition is stored in a moisture-tight container. A suitable container is in particular a drum, a bulk container, a hobbock, a pail, a can, a pouch, a canister or a bottle. The composition is storage-stable, and can therefore be kept in the container in question for several months up to a year or longer, prior to its application, without any significant alteration in its properties to an extent relevant for its service.

Curing by chemical reaction begins after application of the composition. The silane groups undergo hydrolysis with release of alcohol, forming silanol groups (Si—OH groups) and, through subsequent condensation reactions, siloxane groups (Si—O—Si groups). As a result of these and possibly further reactions, the composition cures to give a crosslinked polymer. If the water for hydrolysis of the silane groups was not already present on the substrate or has been preliminarily applied thereon or onto the freshly applied composition, it may come from the air (atmospheric humidity) or naturally from a substrate, or the composition may be contacted, by coating, spraying or mixed incorporation, for example, with a water-containing component.

Curing takes place typically at ambient temperature, and typically extends over a few hours or days until it is largely at an end under the prevailing conditions.

The moisture-curable composition as described above is applied the method for coating a surface according to the present invention using the following steps:
a) applying a first layer of the moisture-curable composition onto a surface,
b) optionally letting the applied moisture-curable composition cure into a dried first layer,
c) applying a second layer of said moisture-curable composition onto the optionally dried first layer.

Thus, the method for coating a surface is a multi-layer coating process with at least two layers of moisture curable composition applied.

The first layer can be cured into a dried layer before the overlapping second layer is applied, with a drying time after step a) of at least 48 hours, preferably at least 72 hours, before step c) is performed. Step c) may be performed days after step a), with complete drying of the composition layer applied in step a), without any significant loss of intercoat adhesion.

However, the method also works when the first layer is not yet dried, with a so-called wet-on-wet application.

Nevertheless, one significant advantage of the method according to the present invention is that the composition is able to form strong intercoat adhesion also when the first layer is partially or fully dried. This allows the user of the method a more flexible, consumer-friendly approach in their coating process, with longer possible waiting times between application of the individual layers and without the risk of resulting poor intercoat adhesion, as it is the case with many currently available coating compositions.

The composition applied in the method according to the present invention preferably exhibits an intercoat adhesion, by peel adhesion using an overcoating time of 7 days under a climate of 20° C. and 50% r.h., of at least 15 N/mm, preferably at least 20 N/mm, in particular at least 25 N/mm.

On application, the freshly mixed composition, still liquid, is applied as a coating or a sealing membrane, to a level or slightly inclined surface, typically by pouring it onto a substrate and then spreading it two-dimensionally until the desired layer thickness is reached, by means of a brush, roller, a slider, a notched trowel or a spatula, for example.

The freshly mixed composition preferably has a viscosity at 20° C. in the range from 0.05 to 8.0 Pas, preferably 0.05 to 6.5 Pas, especially 0.05 to 5.0 Pas, most preferably 0.05 to 4.0 Pas. The composition can therefore be worked well as a sealing membrane for liquid application. It is preferably self-levelling, meaning that it levels of its own accord to give an even surface after it has been worked by means of a brush, roller, notched trowel, spiked roller or the like.

In one operation, typically a layer thickness in the range from 0.5 to 3 mm, especially 0.75 to 2.5 mm, is applied.

The method using the above defined composition can be applied to a variety of substrates, and on curing results in the sealing membrane in the form of an elastic coating that protects the substrate from water penetration.

The composition or sealing membrane is applied in one or more layers. One or more finishing coats may be applied to the layer system. As a topmost or final layer, a seal may be applied.

This “seal” is a transparent or pigmented, high-grade coating which is applied as the uppermost, thin layer to a coating. It protects and enhances the surface of the coating and closes pores that are still present. The layer thickness of a seal (in dry state) is typically in the range from 0.03 to 0.3 mm.

The seal offers additional protection from UV light, oxidation or microbial growth, affords opportunities for aesthetic design, protects the coating from mechanical attacks, prevents soiling and/or makes cleaning easier.

The liquid-applied composition or sealing membrane may be employed using the method according to the present invention for the sealing of roofs, especially flat roofs or gently inclined roof areas, roof terraces or roof gardens, or else of planting vessels, balconies, patios, squares or building foundations, or in the interior of buildings for water sealing, as for example beneath tiles or ceramic slabs in wet cells, kitchens, industrial halls or manufacturing spaces. It can also be used for purposes of repair, on leaking roof membranes, for example.

It is preferably employed on a roof, more particularly a flat roof or gently inclined roof. It can be used for sealing on a new roof or for the purposes of repair. The sealing membrane is also particularly suitable for detailed work, such as angled geometries, pipe penetrations or built-on constructions such as, for example, photovoltaic systems, photothermal systems or air conditioning systems, on a roof where sealing is to take place.

The composition or sealing membrane is used with preference in a roof sealing system comprising
optionally a primer and/or a base coat and/or a repair compound or levelling compound,
at least one layer of the composition described, in a layer thickness of 0.5 to 3 mm, optionally in combination with a mechanical reinforcement,
optionally a finishing coat and/or seal coat.

Suitable mechanical reinforcement comprises in particular a reinforcing fabric such as, more particularly, a plastic mesh or fibers or a fleece mat, more particularly a woven polyester fleece mat or a fleece mat made from non-woven polyester fibers or non-woven glass fibers or a chopped strand glass fiber mat.

Where a mechanical reinforcement is used in the form of a reinforcing fabric or a mat, it is laid preferably onto the freshly applied first layer of the composition and is incorporated into the composition while wet, by means of a roller or brush, for example. After the curing of the composition with the incorporated mechanical reinforcement, a further layer of the composition and/or a finishing coat and/or a seal may be applied thereto.

Where fibers are used, they may be mixed into the liquid composition before it is applied or they may be scattered into the applied composition while it is still liquid.

A further aspect of the present invention is the moisture-curable composition to be used in the method as described above.

Yet another aspect of the present invention is a cured, multi-layered composition obtained from the method as described above.

Suitable substrates to which the composition or sealing membrane can be applied are, in particular
concrete, lightweight concrete, mortar, brick, shingle, roof tile, slate, gypsum, anhydride or natural stone such as granite or marble;
repair or levelling compounds based on PCC (polymer-modified cement mortar) or ECC (epoxy resin-modified cement mortar);
metals and alloys such as aluminum, copper, iron, steel, nonferrous metals, including surface-finished metals and alloys such as galvanized or chromed metals;
asphalt or bitumen;
plastics such as PVC, ABS, PC, PA, polyester, PMMA, SAN, epoxy resins, phenolic resins, polyurethane, POM, polyolefins such as polyethylene and polypropylene, EPM or EPDM, each untreated or surface-treated by plasma, corona or flaming; especially PVC, polyolefin or EPDM films;
insulation foams, especially made of EPS, XPS, polyurethane, PIR, rockwool, glass wool or foamed glass;
coated substrates such as painted tiles, coated concrete or powder-coated metals.

As and when necessary, the substrates may be pretreated before the composition or sealing membrane is applied, examples of such pretreatment being by physical and/or chemical cleaning methods, as for example abrading, sandblasting, shotblasting, brushing, removal by suction or by blowing, jetting with high-pressure or ultra-high pressure water, and/or by treatment with cleaners or solvents, and/or by application of an adhesion promoter, adhesion promoter solution or primer.

Application according to the method of the present invention and curing of the composition or sealing membrane affords an article sealed or coated with the composition described. The article more particularly is an edifice, more particularly an edifice in building construction or in civil engineering.

The described method features advantageous properties. The composition or sealing membrane for application in liquid form is stable on storage in the form of a one-component or multi-component composition. The composition or sealing membrane cures rapidly and reliably under ambient conditions to form an elastic material with suitable strength, stretchability and tear resistance and with a modulus of elasticity that is not too high. The composition or sealing membrane has a low toxicity and hence requires no special protective measures for safe use.

### EXAMPLES

Adduced hereinafter are working examples which are intended to elucidate the invention described in detail. It will be appreciated that the invention is not restricted to these described working examples.

“Standard climatic conditions” refer to a temperature of 23±1° C. and a relative air humidity of 50±5%. “SCC” stands for “standard climatic conditions”.

Silane Group-Containing Polymer Used:

STP Polymer-1:

In the absence of moisture, 1000 g of Acclaim® 12200 polyol (from Covestro; low monool polyoxypropylenediol, OH number 11.0 mg KOH/g, water content around 0.02 wt %), 62.5 g of isophorone diisocyanate (Vestanat® IPDI from Evonik Industries), 131.2 g of triethylene glycol bis(2-ethylhexanoate) (TEG-EH from Eastman) and 0.3 g of Coscat 83 (from Vertellus) were heated to 90° C. with continuous stirring and left at this temperature until the free isocyanate group content as determined by titrimetry had reached a value of 1.32 wt %. Subsequently, 144.9 g of diethyl N-(3-trimethoxysilylpropyl)aminosuccinate were mixed in and the mixture was stirred at 90° C. until it was no longer possible to detect any free isocyanate by means of FT-IR spectroscopy. The silane-functional polymer was cooled to room temperature and stored in the absence of moisture. It was liquid at room temperature and had a viscosity at ° C. of 3.5 Pa·s

STP Polymer-1 contains 11% by weight of plasticizer (triethylene glycol bis(2-ethylhexanoate)).

Further Substances Used:

| | |
|---|---|
| OCTMO | Octyltrimethoxysilane; Dynasylan ® OCTMO (Evonik) |
| DMM | Dipropylene glycol dimethyl ether; PROGLYDE ™ DMM |
| | (Dow) |
| PGDA | Propylene glycol diacetate; DOWANOL ™ PGDA (Dow) |
| DPM | Dipropylene glycol monomethyl ether; DOWANOL ™ |
| | DPM (Dow) |
| DPnP | Dipropylene glycol monopropyl ether; DOWANOL ™ |
| | DPnP (Dow) |
| TOU | 2,5,7,10-Tetraoxaundecane; Tetraoxaundecan |
| | SOLVAGREEN ® (Carl Roth) |
| PC | Propylene carbonate; Propylene carbonate (Sigma Aldrich) |
| TEG-EH | Triethylene glycol bis(2-ethylhexanoate); Eastman ™ |
| | TEG-EH (Eastman) |
| VTMO | Vinyltrimethoxysilane; Geniosil ® XL 10 (Wacker); |
| | (moisture scavenger) |
| UV-A | UV absorber (organic) |
| UV-S | UV stabilizer (Hindered Amine Light Stabilizer) |
| TiO₂ | Titanium dioxide (white pigment) |
| Pigment | Black pigment |
| ATH | Aluminium trihydroxide Al(OH)₃ (filler) |
| CaCO₃ | Calcium carbonate (chalk) (filler) |
| SiO₂ | Pyrogenic silica (reinforcement/rheology modifier) |
| AMMO | 3-Aminopropyltrimethoxysilane; Dynasylan ® AMMO |
| | (Evonik) (catalyst) |
| DBTDL | Dibutyltin dilaurate (catalyst) |
| D-400 | Polyetherdiamine based on polypropylene glycol with terminal |
| | primary amino groups (average molecular weight 430 g/mol); |
| | Jeffamine ® D-400 (Huntsman) |
| D-230 | Polyetherdiamine based on polypropylene glycol with terminal |
| | primary amino groups (average molecular weight 230 g/mol); |
| | Jeffamine ® D-230 (Huntsman) |

Production of Sealing Membranes:

For each sealing membrane, the ingredients specified in tables 1 and 2 were mixed in the specified amounts (in parts by weight) by means of a centrifugal mixer (SpeedMixer™ DAC 150, FlackTek Inc.) or by means of a high speed disperser into a homogeneous liquid and stored with exclusion of moisture.

The following test protocol was applied:

24 hours after mixing, the viscosity of each composition was determined at on a thermostated Rheotec RC30 cone-plate viscometer (cone diameter 25 mm, cone angle 1°, cone tip-plate distance 0.05 mm, shear rate 10 rpm) or on a Rotothinner™ (according to principles outlined in BS 3900-A7).

The full through-cure was determined by applying the composition as described in a first reinforced layer followed by a second layer onto a wet first layer under SCC. Films that exhibited full though cure after 24 hours were given a “pass” result, while incomplete through-cure in sample films led to a “fail” result.

To measure the time until the composition became free from tack, or tack-free time abbreviated to “TFT”, a small portion of the mixed composition at room temperature was applied in a layer thickness of around 3 mm to cardboard and, under standard conditions, a determination was made of the time which elapsed until an LDPE pipette used to gently touch the surface of the composition for the first time no longer had any residues left on it.

To determine the intercoat adhesion, the composition was applied in a first reinforced layer and a wet-on-wet second layer. The sample was left to cure and condition for hours/days respective to the overcoat time to be tested. Once the desired conditioning period was reached, the first reinforced layer was applied directly on top of the conditioned sample (with a bond-break) and the wet-on-wet second layer was subsequently applied. The combined sample was left to cure and condition for seven days from the time overcoating was carried out. Samples were cut to a width of 50 mm and a minimum length of 120 mm.

Testing was conducted in accordance with the principles outlined in ISO 8510-2:2006 Adhesives—Peel test for a flexible-bonded-to-rigid test specimen assembly—Part 2:180° Peel).

The results are reported in table 3. Examples 1-1 to 1-4 are compositions according to the invention, while examples R-1 to R-8 are reference example compositions not according to the invention.

TABLE 1
Composition of examples R-1, R-2, and R-8 and I-1 to I-3.
All numbers are in weight parts.

| (weight parts) | R-1 | I-1 | I-2 | I-3 | R-2 | R-8 |
|---|---|---|---|---|---|---|
| STP Polymer-1 | 35.4 | 35.4 | 35.4 | 35.4 | 35.4 | 35.4 |
| OCTMO | 20 | — | — | — | — | — |
| DMM | — | 15 | 20 | 25 | — | — |
| PGDA | — | — | — | — | 20 | — |
| D-230 | | | | | | 20 |
| VTMO | 1 | 1 | 1 | 1 | 1 | 1 |
| UV-A | 0.9 | 0.9 | 0.9 | 0.9 | 0.9 | 0.9 |
| UV-S | 0.1 | 0.1 | 0.1 | 0.1 | 0.1 | 0.1 |
| TiO₂ | 6.2 | 6.2 | 6.2 | 6.2 | 6.2 | 6.2 |
| Pigment | 0.6 | 0.6 | 0.6 | 0.6 | 0.6 | 0.6 |
| ATH | 15.7 | 15.7 | 15.7 | 15.7 | 15.7 | 15.7 |
| CaCO₃ | 12.5 | 12.5 | 12.5 | 12.5 | 12.5 | 12.5 |
| SiO₂ | 3 | 3 | 3 | 3 | 3 | 3 |
| AMMO | 1 | 1 | 1 | 1 | 1 | 1 |
| DBTDL | 0.06 | 0.06 | 0.06 | 0.06 | 0.06 | 0.06 |

TABLE 2
Composition of examples R-3 to R-7 and I-4. All numbers
are in weight parts.

| (weight parts) | R-3 | R-4 | I-4 | R-5 | R-6 | R-7 |
|---|---|---|---|---|---|---|
| STP Polymer-1 | 35.4 | 35.4 | 35.4 | 35.4 | 35.4 | 35.4 |
| DPM | 20 | — | — | — | — | — |
| DPnP | — | 20 | — | — | — | — |
| TOU | — | — | 20 | — | — | — |
| PC | — | — | — | 20 | — | — |
| TEG-EH | — | — | — | — | 20 | — |
| D-400 | | | | | | 20 |
| VTMO | 1 | 1 | 1 | 1 | 1 | 1 |
| UV-A | 0.9 | 0.9 | 0.9 | 0.9 | 0.9 | 0.9 |
| UV-S | 0.1 | 0.1 | 0.1 | 0.1 | 0.1 | 0.1 |
| TiO₂ | 6.2 | 6.2 | 6.2 | 6.2 | 6.2 | 6.2 |
| Pigment | 0.6 | 0.6 | 0.6 | 0.6 | 0.6 | 0.6 |
| ATH | 15.7 | 15.7 | 15.7 | 15.7 | 15.7 | 15.7 |
| CaCO₃ | 12.5 | 12.5 | 12.5 | 12.5 | 12.5 | 12.5 |
| SiO₂ | 3 | 3 | 3 | 3 | 3 | 3 |
| AMMO | 1 | 1 | 1 | 1 | 1 | 1 |
| DBTDL | 0.06 | 0.06 | 0.06 | 0.06 | 0.06 | 0.06 |

TABLE 3
Test data (full through-cure test, viscosity, and intercoat adhesion) of examples I-1 to I-4 and
R-1 to R-8.

| | Full | | Intercoat | Intercoat | Intercoat | Intercoat |
|---|---|---|---|---|---|---|
| | through- | Viscosity | adhesion | adhesion | adhesion | adhesion |
| Example | cure | (Pa · s) | (N/50 mm) | (N/50 mm) | (N/50 mm) | (N/50 mm) |
| composition | 24 h | 24 h | 1 d | 3 d | 6 d | 7 d |
| R-1 | Pass | 2.4 | 47 | 10 | 9 | 9 |
| I-1 | Pass | 5.9 | 52 | 51 | 38 | 17 |
| I-2 | Pass | 2.7 | 32 | 31 | 31 | 32 |
| I-3 | Pass | 1.5 | n/m | n/m | n/m | 22 |
| R-2 | Fail | >6.5 | 56 | 33 | 44 | 44 |
| R-3 | Fail | >6.5 | 50 | 30 | 27 | 19 |
| R-4 | Fail | >6.5 | 41 | 41 | 34 | 29 |
| I-4 | Pass | 3.0 | n/m | n/m | n/m | 28 |
| R-5 | Fail | >6.5 | n/m | n/m | n/m | n/m |
| R-6 | Pass | >6.5 | n/m | n/m | n/m | n/m |
| R-7 | Pass | >6.5 | n/p | n/p | n/p | n/p |
| R-8 | Pass | >6.5 | n/p | n/p | n/p | n/p |

“n/m.” stands for “not measured”.
“n/p” means that the measurement was not possible due to severe migration of liquids to surface of first coating layer after 24 h.

Table 3 shows that reference examples R-2, R-3, R-4, and R-5 did not show sufficient through-cure in the test layer after 24h.

Viscosity was excellent in examples R-1, 1-2, 1-3, and 1-4, and it was sufficient in example 1-1. Examples R-2, R-3, R-4, R-5, R-6, R-7, and R-8 all did show too high viscosity for ideal application as liquid-applied membrane.

R-1 already after 3 days did not provide a suitable intercoat adhesion anymore. Examples R-7 and R-8 were not possible to properly assess for intercoat adhesion properties. In both cases, especially in R-8, there was a strong formation of a greasy liquid layer on the surface of the first applied layer after 24h, possibly a surface migration of the polyetherdiamine, which made further analysis of the intercoat adhesion impossible.

Only the examples according to the present invention within this test series exhibited a good or excellent intercoat adhesion even after 7 days, together with excellent through-cure and a sufficiently low viscosity for use as a liquid applied membrane.

1. A method for coating a surface, comprising the steps:
a) applying a first layer of a moisture-curable composition onto a surface,
b) optionally letting the applied moisture-curable composition cure into a dried first layer,
c) applying a second layer of the moisture-curable composition onto the optionally dried first layer,
wherein the moisture-curable composition comprises
between 20 and 50 wt. %, based on the total weight of the composition, of at least one organic polymer which is liquid at room temperature and contains reactive silane groups, and
between 10 and 30 wt. %, based on the total weight of the composition, of at least one polyether PE having between 2 and 6 ether oxygen atoms and is free of hydroxyl groups; and
at least one curing catalyst for reactive silane groups.

2. The method as claimed in claim 1, wherein the polymer containing silane groups is a polyether containing silane groups.

3. The method as claimed in claim 2, wherein the polyether containing silane groups contains urethane groups and/or urea groups additionally to the silane groups.

4. The method as claimed in claim 1, wherein in the first layer is letting to be cured into a dried first layer before the second layer is applied, with a drying time after step a) of at least 48 hours before step c) is performed.

5. The method as claimed in claim 1, wherein the moisture-curable composition additionally comprises between 10 wt.-% and 50 wt.-% of at least one filler.

6. The method as claimed in claim 1, wherein the polyether PE contains between 4 and 12 carbon atoms and the ether oxygen atoms are bridged by 1 or 2 carbon atoms.

7. The method as claimed in claim 6, wherein the polyether PE is selected from dipropylene glycol dimethyl ether, dipropylene glycol diethyl ether, dipropylene glycol dibutyl ether, dipropylene glycol dipropyl ether, and 2,5,7,10-tetraoxaundecane.

8. The method as claimed in claim 1, wherein the moisture-curable composition contains less than 5 wt.-%, based on the total composition, of aliphatic or aromatic alkylalkoxysilanes.

9. The method as claimed in claim 1, wherein the curing catalyst is a combination of a primary aminosilane and a metal complex, said metal complex in particular being a tin complex.

10. The method as claimed in claim 9, wherein the composition comprises between 0.5 and 1.0 wt.-% of the primary aminosilane and between 0.01 and 0.1 wt.-% of the metal complex.

11. The method as claimed in claim 1, wherein the composition additionally comprises at least one further constituent selected from moisture scavengers, UV absorbers and stabilizers, pigments, and rheology modifiers.

12. The method as claimed in any claim 1, wherein the surface to be coated is a roof of a building.

13. The moisture-curable composition to be used in the method as claimed in claim 1.

14. A cured multilayer coating obtained from the method as claimed in claim 1.

15. A roof sealing system comprising
optionally a primer and/or a base coat and/or a repair or levelling compound,
at least two layers of the composition as described in claim 1 in a thickness of each layer of 0.5 to 3 mm, optionally in combination with a mechanical reinforcement,
optionally a topcoat and/or seal coat.
